(19) United States
(12) Patent Application Publication
(10) Pub. No.: US 2026/0316674 A1
(43) Pub. Date: Oct. 15, 2026

(54) VEHICULAR EXTERIOR MIRROR WITH VIBRATION DAMPENING

(71) Applicant: Magna Mirrors of America, Inc., Holland, MI (US)

(72) Inventor: Rudy A. Morey, Hudsonville, MI (US)

(21) Appl. No.: 19/461,850

(22) Filed: Jan. 28, 2026

Related U.S. Application Data
(60) Provisional application No. 63/754,635, filed on Feb. 6, 2025.

(51) Int. Cl. B60R 1/072; B60R 1/074

(52) U.S. Cl. CPC B60R 1/072; B60R 1/074

(57) ABSTRACT

A vehicular exterior rearview mirror assembly includes a mirror head disposed at mounting structure configured to mount the mirror assembly at a side of a vehicle. The mirror head accommodates a mirror reflective element that provides a rearward view at the side of the vehicle. An actuator is accommodated within the mirror head and is electrically operable to adjust the mirror reflective element relative to the mirror head to adjust the rearward view. The actuator includes a rocker arm. When the actuator is electrically operated to adjust the rearward view for the driver, the rocker arm moves to adjust the mirror reflective element relative to the mirror head. The rocker arm is coupled to the mirror reflective element via a dampening mechanism that mitigates transfer of vibrations from the mounting structure and the actuator to the mirror reflective element.

### CROSS REFERENCE TO RELATED APPLICATION

The present application claims the filing benefits of U.S. provisional application Ser. No. 63/754,635, filed Feb. 6, 2025, which is hereby incorporated herein by reference in its entirety.

### FIELD OF THE INVENTION

The present invention relates generally to the field of rearview mirror assemblies for vehicles and, more particularly, to an exterior rearview mirror assembly that is operable to adjust a rearward field of view of the driver of the vehicle.

### BACKGROUND OF THE INVENTION

Typically, an exterior rearview mirror assembly includes a mirror actuator that is operable to adjust a mirror reflective element relative to the mirror casing so as to adjust a rearward view of the driver of the vehicle. The reflective element and actuator are disposed in the mirror casing and the actuator adjusts the reflective element relative to the mirror casing. Powerfold exterior mirror assemblies include an actuator disposed at a mounting structure that pivots or folds the mirror casing relative to the side of the vehicle.

### SUMMARY OF THE INVENTION

The present invention provides a rearview mirror assembly (such as an exterior mirror assembly mounted at a side of an equipped vehicle) that includes a mirror head disposed at mounting structure configured to mount the mirror assembly at the side of the vehicle. The mirror head includes a mirror reflective element. With the vehicular exterior rearview mirror assembly mounted at the side of the vehicle, the mirror reflective element provides a rearward view at the side of the vehicle to a driver of the vehicle. An actuator is accommodated within the mirror head and attached to the mirror head. The actuator is electrically operable to move the mirror reflective element relative to the mirror head to adjust the rearward view for the driver of the vehicle. The actuator includes at least one rocker arm attached to the mirror reflective element. When the actuator is electrically operated to adjust the rearward view for the driver of the vehicle, the actuator adjusts at least one rocker arm to move the mirror reflective element relative to the mirror head. A dampening mechanism is disposed between the rocker arm and the mirror reflective element, and the dampening mechanism attenuates vibrations from transferring through the mounting structure, mirror head and the actuator to the mirror reflective element.

For example, the dampening mechanism may include a link element disposed between an end of the rocker arm and a mirror back plate attached to the mirror reflective element. A biasing element is disposed between the end of the rocker arm and the link element and urges the link element in a direction away from the end of the rocker arm. The biasing element expands and contracts and the link element moves relative to the end of the rocker arm to attenuate vibrations from travelling through the rocker arm to the mirror reflective element.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle equipped with an exterior rearview mirror assembly;

FIG. 2 is a view of the exterior rearview mirror assembly attached at the side of the vehicle;

FIG. 3 is a perspective view of the exterior rearview mirror assembly in an extended position relative to the side of the vehicle;

FIG. 4 is a perspective view of the exterior rearview mirror assembly in a folded position relative to the side of the vehicle;

FIG. 5 is an exploded view of a mirror back plate and a glass case of an exterior rearview mirror assembly with spring fingers between the mirror back plate and the glass case;

FIG. 6 is a sectional view of an actuator attached to a mirror back plate via rocker bodies with dampening mechanisms disposed between the rocker bodies and the mirror back plate to attenuate vibrations from travelling through the actuator to the mirror reflective element;

FIG. 7 is another sectional view of the actuator attached to the mirror back plate with the mirror reflective element removed from the mirror back plate;

FIG. 8 is an exploded view of a rocker body and the dampening mechanisms;

FIG. 9 is a perspective view of a dampening mechanism disposed at an end portion of the rocker body;

FIG. 10 is a sectional view of the rocker body attached to the mirror back plate; and

FIG. 11 is an exploded view of the mirror reflective element, mirror back plate, and the actuator with rocker bodies and dampening mechanisms.

### DESCRIPTION OF THE PREFERRED EMBODIMENTS

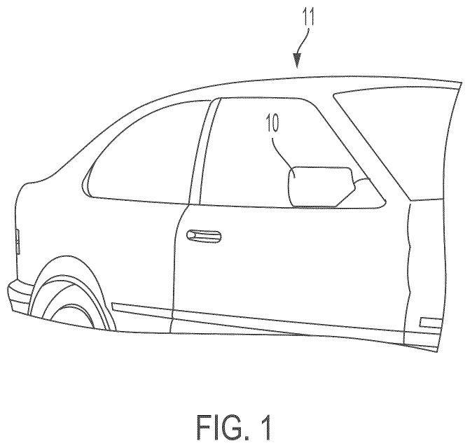

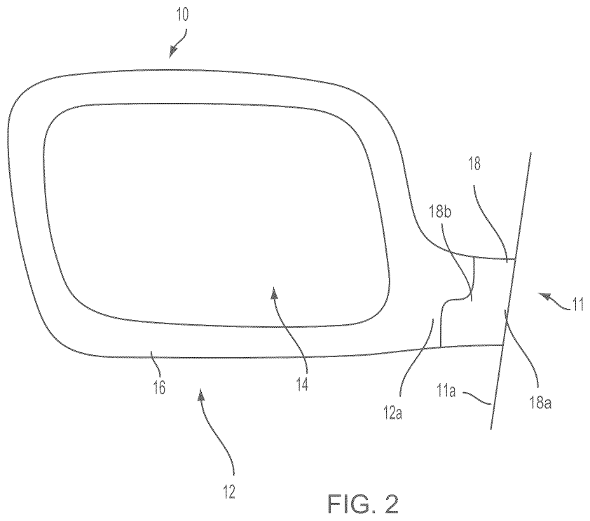

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIGS. 1 and 2). The mirror head portion 12 includes a mounting portion 12a that is pivotally or movably mounted to a mounting arm or base portion 18. The mirror assembly 10 may comprise a powerfold mirror (where the mirror head portion may be pivoted via an actuator assembly or adjustment device), and/or the mirror assembly may comprise a breakaway mirror (where the mirror head portion may be manually pivoted about the mounting arm or base). The mounting arm or base 18 of the mirror assembly 10 is mounted at the side 11a of the vehicle 11, with the reflective element 14 providing a rearward field of view along the respective side of the vehicle 11 to the driver of the vehicle.

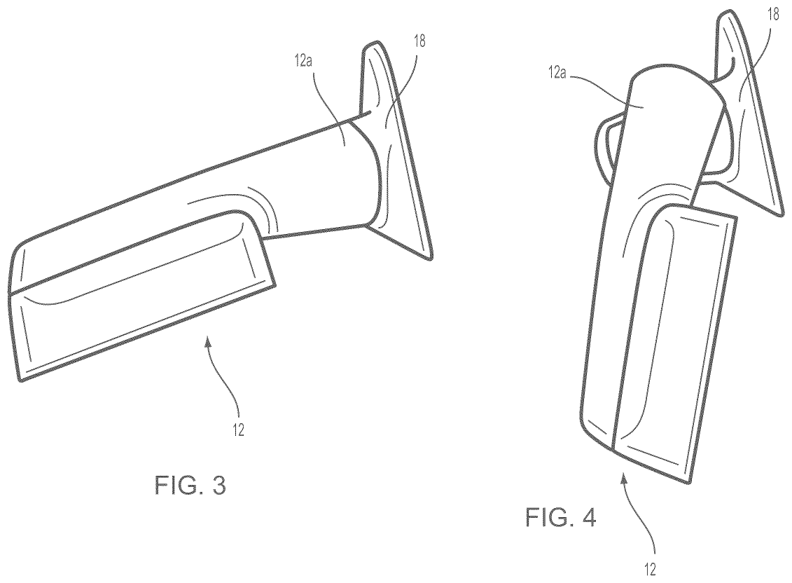

The mirror head 12 may be adjustable relative to the mounting arm 18 at least between a use or drive or extended position (FIG. 3), where the mirror head 12 is extended relative to the side of the vehicle 11 and the mounting arm 18 to provide the view to the driver of the vehicle rearward and along the side of the vehicle, and a non-use or folded or park position (FIG. 4), where the mirror head 12 is folded or pivoted in from the extended position relative to the mounting arm 18 to be disposed along the side of the vehicle 11. For example, an electrically operable actuator may be operable to adjust the mirror head 12 between the extended position and the folded position. Optionally, the mirror head 12 may also be manually pivoted to a fully forward position, where the mirror head 12 is pivoted or rotated beyond the drive position, such as in response to impact of the mirror head 12 with an object. A seal may be disposed along the interface between the mounting portion 12a of the mirror head 12 and the mounting arm 18.

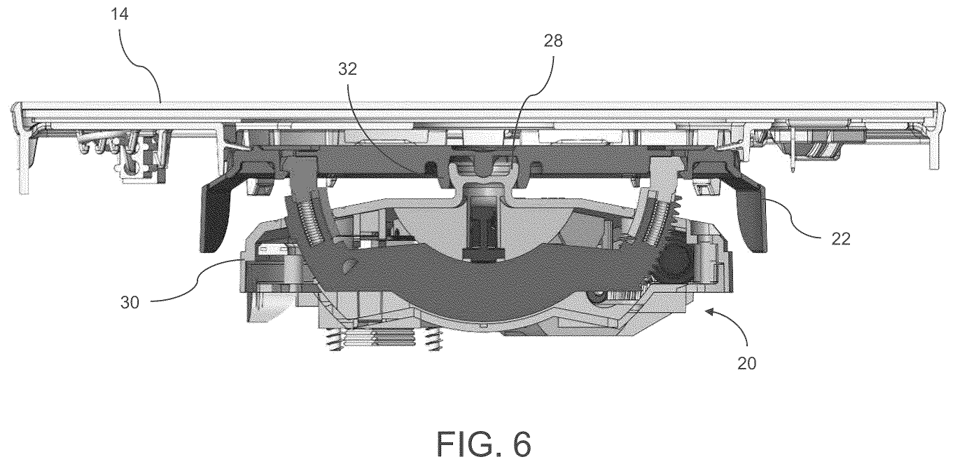

With the mirror head 12 in the extended position, an actuator 20 is operable to adjust the mirror reflective element 14 relative to the mirror casing 16 to adjust the rearward field of view provided to the driver of the vehicle (FIG. 6). That is, the mirror reflective element 14 may be adjusted within or relative to the mirror casing 16 when adjusting the rearward field of view provided by the mirror assembly. For example, the mirror reflective element 14 may be attached to a back plate 22 at the rear of the mirror reflective element 14 and the back plate 22 and the mirror reflective element 14 may be adjusted together and in tandem via operation of the actuator 20 accommodated within the mirror head 12.

During driving, with the mirror head in the extended position, a typical mirror reflective element may experience undesirable vibrations, which can interfere with the rearward view provided by the mirror reflective element. For example, vibrations experienced at the mounting arm may travel through the actuator to the mirror reflective element. This can be due to stiffness of the actuator, vehicle door stiffness, mounting constraints and the like. Glass vibration may reduce clarity of the rearward view provided by the mirror reflective element and cause the driver to become distracted or disoriented when using the mirror to obtain the rearward view, leading to a potential safety hazard, and glass vibration may lower the perceived quality of the mirror assembly or the vehicle as a whole.

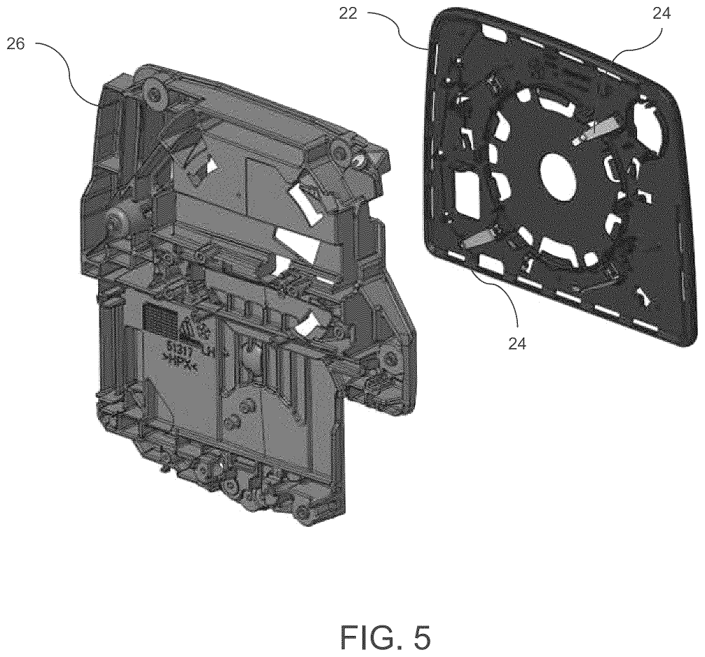

To reduce vibrations at the mirror glass, the stiffness of components between the mirror glass and the vehicle door may be optimized. Optionally, one or more spring fingers 24 may be disposed between a glass case or attaching portion or holder 26 (that accommodates or is attached to the mirror reflective element) and the back plate or mirror bracket 22 (FIG. 5). The spring finger 24 may add spring damping between the glass case 26 and the mirror bracket 22 to at least partially attenuate or absorb or mitigate vibrations that may transfer to the mirror reflective element 14. In other words, the spring fingers 24 may connect the attaching portion 26 at the mirror reflective element 14 and the mirror back plate 22 so that, when the actuator 20 is operated and imparts movement of the mirror back plate 22, the mirror reflective element 14 and attaching portion 26 move together and in tandem with the mirror back plate 22. With the actuator 20 not operating such that the view provided by the mirror reflective element 14 is set, the spring fingers 24 attenuate or at least partially absorb or mitigate vibrations that travel or transfer from the actuator 20 and mirror back plate 22 to the attaching portion 26 and mirror reflective element 14, where the vibrations may otherwise cause movement of the mirror reflective element. This improves the rearward view provided to the driver of the vehicle via the mirror reflective element 14.

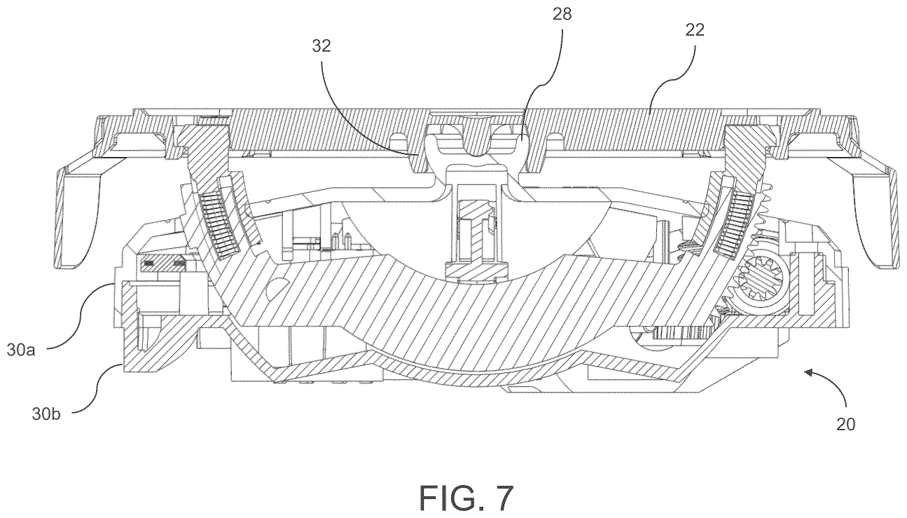

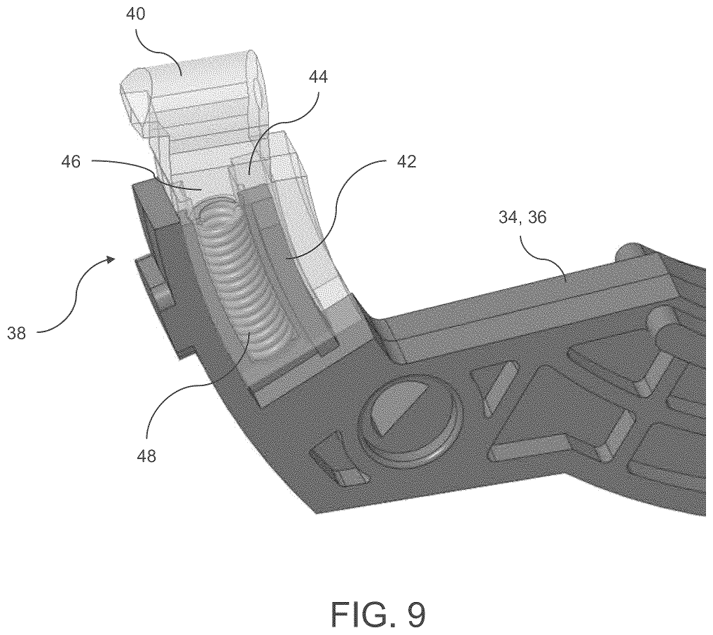

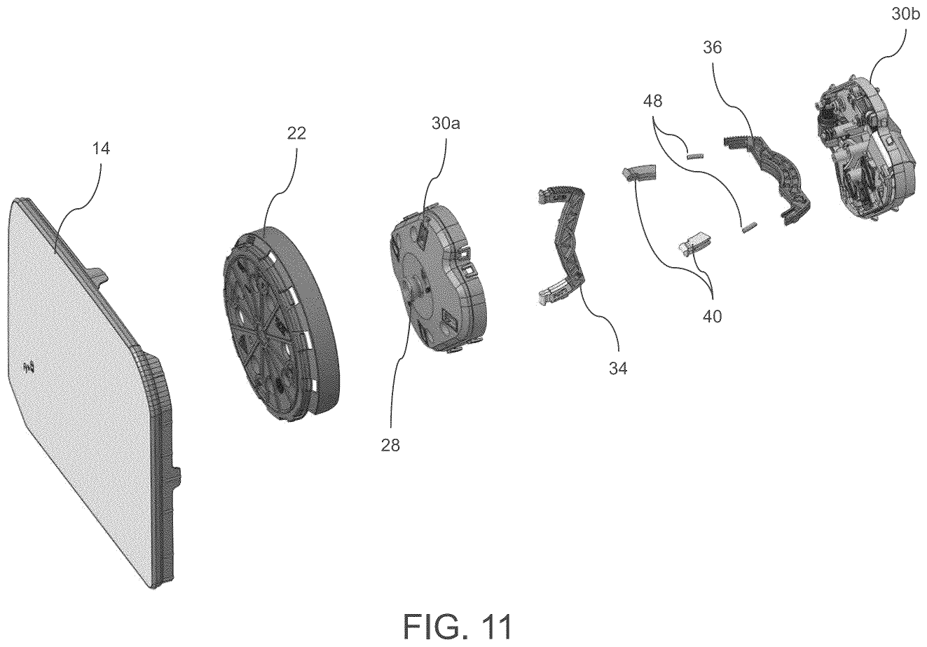

Referring to FIGS. 6-11, the mirror back plate 22 attached at the rear side of the mirror reflective element 14 may attach to a toggle or pivot or ball element 28 of the actuator 20 such that the back plate 22 and mirror reflective element 14 are pivotable relative to the actuator 20 about the pivot element 28. The actuator 20 may be fixed or secured or non-movable relative to the mirror casing 16 when adjusting the mirror reflective element 14 relative to the mirror casing 16. In the illustrated example, the actuator 20 includes a housing 30 having a first portion or upper housing portion 30a and a second portion or lower housing portion 30b that join together and accommodate one or more electrically operable motors and associated gear trains within the actuator housing 30. The pivot element 28 is disposed at or integrally formed with the upper housing portion 30a and is received at a socket element or receiving portion 32 of the back plate 22.

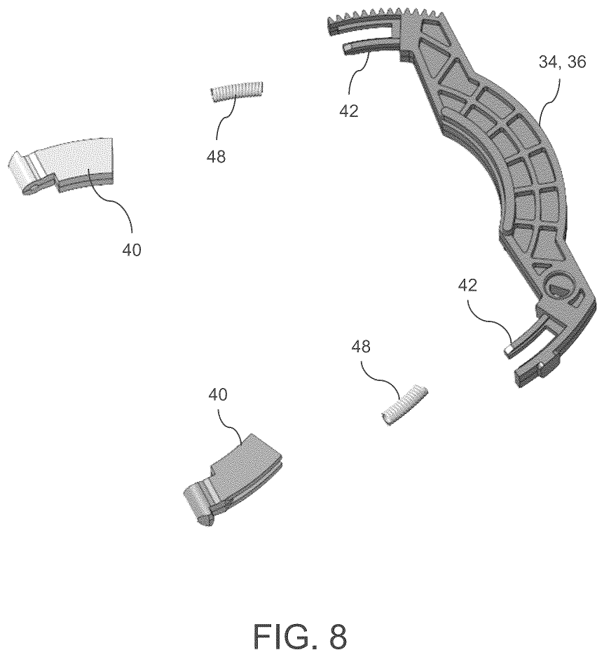

The actuator 20 further includes a first rocker body or rocker arm 34 and a second rocker body or rocker arm 36 (FIGS. 8, 9 and 11) that each respectively attach to the mirror back plate 22 and that are adjustable relative to the actuator housing 30 to adjust the mirror reflective element 14 relative to the mirror casing 16. Each of the first rocker body 34 and the second rocker body 36 extend from within the actuator housing 30 through respective apertures in the upper housing portion 30a to attach to the mirror back plate 22. The actuator 20 is operable to pivot the first rocker body 34 and the second rocker body 36 about respective axes to adjust the mirror reflective element 14 about respective axes. For example, the first rocker body 34 may be adjustable about a substantially horizontal axis to tilt the mirror reflective element 14 upward or downward at the side of the vehicle and the second rocker body 36 may be adjustable about a substantially vertical axis to tilt the mirror reflective element 14 inward or outward at the side of the vehicle.

Thus, the actuator 20 may be attached to the mirror casing 16 and operably coupled to the mirror reflective element 14 via the first rocker body 34 and the second rocker body 36. To prevent or reduce vibrations from transferring through the actuator 20 to the mirror reflective element 14, a dampening mechanism 38 may be disposed between one or more of the respective ends of the first rocker body 34 and the second rocker body 36 and the mirror back plate 22. In other words, the first rocker body 34 and the second rocker body 36 may attach to the mirror back plate 22 via one or more dampening mechanisms 38 and the dampening mechanisms 38 at least partially attenuate or absorb or mitigate vibrations travelling from the actuator 20 to the mirror reflective element 14.

As shown in FIGS. 8-10, each dampening mechanism 38 includes an end linkage 40 disposed at an end of the rocker body and that is movable relative to the rocker body along a rail or guide portion 42 of the rocker body. The end linkages 40 attach to the mirror back plate 22. The rail 42 of the rocker body may be received along a corresponding channel or track 44 of the end linkage 40. Further, the end linkage 40 includes a cavity or recess 46 that accommodates a biasing element 48, such as a coil spring or other suitable compressible or deformable biasing element, between an inner end surface of the end linkage 40 and an outer end surface of the rocker body. The cavity 46 and the biasing element 48 may extend generally in a direction parallel to the rail 42 and the channel 44 so that compression of the biasing element 48 may resist movement of the end linkage 40 toward the rocker body and the biasing element 48 may bias or urge the end linkage along the rail 42 and in a direction away from the rocker body toward the mirror back plate 22.

In some examples, a fluid, such as a high-viscosity grease, is disposed within the cavity 46 of the end linkage 40 to partially resist movement of the linkage 40 relative to the rocker body. That is, the spring 48 and grease may be added to the actuator output. The spring 48 provides a damping load. The grease provides drag and the fluid drag may smooth and/or stabilize movement of the end linkage 40 and mirror reflective element 14 relative to the rocker body 34, 36 and the actuator 20. The resistive drag may be proportional to the size of the greased surface area.

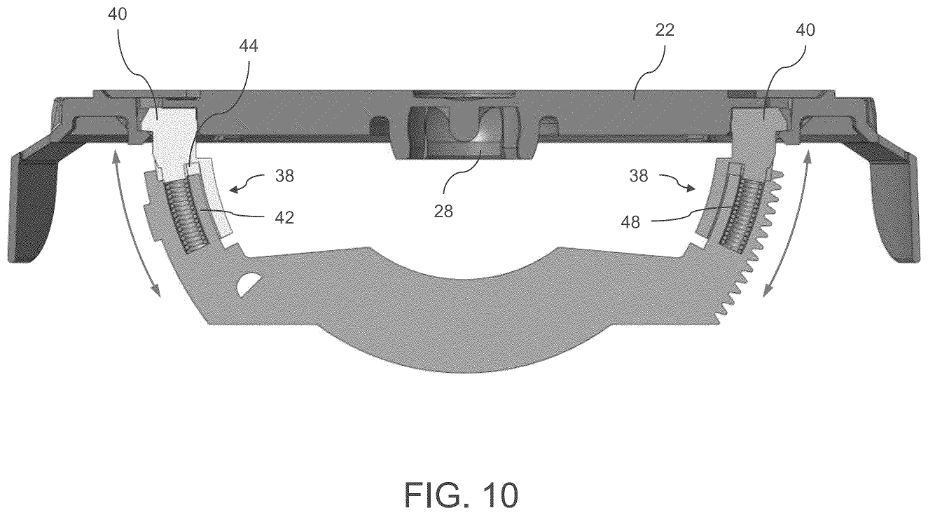

The end linkages 40 and the adaptor plate or mirror back plate 22 may move (at least slightly) independently from the gear train of the actuator 20 and the output rocker bodies. With dampening mechanisms 38 disposed at both ends of each rocker body, the biasing elements 48 may oppose one another about each adjustment axis of the mirror reflective element 14 (FIG. 10). Accordingly, when the actuator 20 is operated to adjust the mirror reflective element 14 relative to the mirror casing 16, the first rocker body 34 and/or the second rocker body 36 are adjusted relative to the actuator housing 30. The dampening mechanisms 38 at the opposing ends of the rocker bodies may allow the mirror back plate 22 to pivot about the pivot element 28 according to movement of the rocker bodies. In other words, the biasing forces of the dampening mechanisms 38 may oppose one another so as to not substantially effect movement of the mirror back plate 22 during operation of the actuator 20. With the position of the mirror reflective element 14 set, the dampening mechanisms 38 may at least partially absorb or attenuate or mitigate vibrations travelling through the rocker bodies to the mirror back plate 22 and the mirror reflective element 14.

Optionally, the mirror assembly and dampening mechanism may utilize characteristics of the mirror assemblies described in U.S. Publication Nos. US-2025-0004293 and/or US-2025-0170959, which are hereby incorporated herein by reference in their entireties.

The mirror assembly may utilize aspects of the mirror assemblies described in U.S. Publication Nos. US-2023-0009664; US-2021-0331625; US-2021-0316664; US-2021-0213880; US-2020-0353867 and/or US-2020-0223364, and/or U.S. Pat. Nos. 11,351,919; 11,325,535; 10,099,618; 9,827,913; 9,487,142; 9,346,403 and/or 8,915,601, which are all hereby incorporated herein by reference in their entireties.

Optionally, the reflective element may comprise a frameless reflective element, such as the types shown and/or described in U.S. Des. Pat. Nos. U.S. Pat. Nos. 7,253,723; 8,154,418; 8,508,831; 8,730,553; 9,598,016 and/or 9,346,403, and/or U.S. Publication Nos. US-2014-0313563 and/or US-2015-0097955, which are hereby incorporated herein by reference in their entireties. In such an application, the mirror reflective element may have a rounded or ground perimeter edge region at its periphery of the front surface, and such a rounded or ground or polished perimeter edge region of the glass substrate of the reflective element may be exposed to, contactable by and/or viewable by the driver of the vehicle and may comprise a polished perimeter that is polished to a water-clear finish and may have a radius of curvature of at least about 2.5 mm. The rounded perimeter edge of the glass substrate of the mirror reflective element may provide a generally smooth or continuous transition from the generally planar (or slightly curved) front surface of the mirror reflective element to the outer surface of the mirror head or mirror casing at which the mirror reflective element is mounted. Optionally, the mirror reflective element may have a thin or very thin bezel at the perimeter region of the front surface of the reflective element, and optionally, the mirror reflective element may have a clear bezel at the perimeter region of the front surface of the reflective element, or the like, depending on the particular application of the mirror assembly and the desired appearance and/or styling of the mirror assembly.

Optionally, other mirror designs or configurations may be contemplated, such as various configurations of the mirror casing and reflective element and any bezel at the mirror reflective element. Optionally, the mirror casing (or separate bezel portion of the mirror casing) may circumscribe the periphery of the mirror reflective element to provide a generally smooth or continuous transition from the generally planar (or slightly curved) front surface of the mirror reflective element to the outer surface of the mirror head or mirror casing at which the mirror reflective element is mounted. For example, the mirror casing may comprise a plastic molding (such as formed via injection molding of a polymeric material) that comprises a portion that (a) abuts a circumferential edge of the mirror glass substrate (such as the front glass substrate of an electrochromic mirror reflective element or a glass prism of a prismatic mirror reflective element) and (b) has an outer curved surface that extends from generally adjacent to a first surface of the glass substrate and that may lack a sharp edge, and that does not encroach onto the outer glass first surface of the glass substrate, such as described in U.S. Pat. Nos. 7,255,541; 7,289,037; 7,360,932; 8,049,640 and/or 8,529,108, which are hereby incorporated herein by reference in their entireties. Optionally, the mirror assembly may include a conventional bezel, such as described in U.S. Pat. No. 7,224,324, which is hereby incorporated herein by reference in its entirety.

The exterior rearview mirror assembly may include a casing, such as described above, or the mirror assembly may comprise or utilize aspects of other types of casings or the like, such as described in U.S. Pat. Nos. 7,338,177; 7,289,037; 7,249,860; 6,439,755; 4,826,289 and/or 6,501,387, which are all hereby incorporated herein by reference in their entireties. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, and/or in U.S. Pat. Pub. Nos. US-2006-0061008 and/or US-2006-0050018, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head disposed at a mounting structure, wherein the mounting structure is configured to mount the vehicular exterior rearview mirror assembly at a side of a vehicle;
wherein the mirror head accommodates a mirror reflective element;
wherein, with the vehicular exterior rearview mirror assembly mounted at the side of the vehicle, the mirror reflective element provides a rearward view at the side of the vehicle to a driver of the vehicle;
an actuator accommodated within the mirror head, wherein, with the vehicular exterior rearview mirror assembly mounted at the side of the vehicle, the actuator is electrically operable to adjust the mirror reflective element relative to the mirror head to adjust the rearward view for the driver of the vehicle;
wherein the actuator comprises a rocker arm coupled to the mirror reflective element, and wherein, when the actuator is electrically operated to adjust the rearward view for the driver of the vehicle, the rocker arm moves to adjust the mirror reflective element relative to the mirror head; and
wherein the rocker arm is coupled to the mirror reflective element via a dampening mechanism, and wherein, with the vehicular exterior rearview mirror assembly mounted at the side of the vehicle, the dampening mechanism mitigates transfer of vibrations from the mounting structure and the actuator to the mirror reflective element.

2. The vehicular exterior rearview mirror assembly of claim 1, wherein the mirror reflective element is attached at a mirror back plate, and wherein the rocker arm is coupled to the mirror reflective element via the dampening mechanism and the mirror back plate.

3. The vehicular exterior rearview mirror assembly of claim 1, wherein the dampening mechanism comprises (i) a linkage disposed at an end portion of the rocker arm and (ii) a biasing element disposed between the linkage and the end portion of the rocker arm, and wherein the linkage is coupled to the mirror reflective element, and wherein the biasing element imparts a biasing force between the linkage and the end portion of the rocker arm to urge the linkage in a direction away from the end portion of the rocker arm, and wherein the linkage moves relative to the end portion of the rocker arm to mitigate transfer of vibrations from the mounting structure and the actuator to the mirror reflective element.

4. The vehicular exterior rearview mirror assembly of claim 3, wherein the biasing element is disposed at least partially within a cavity of the linkage.

5. The vehicular exterior rearview mirror assembly of claim 4, wherein fluid is disposed within the cavity.

6. The vehicular exterior rearview mirror assembly of claim 1, wherein the actuator comprises a housing, and wherein the mirror reflective element is adjustably attached to the housing of the actuator, and wherein, when the actuator is electrically operated to adjust the rearward view for the driver of the vehicle, the rocker arm moves relative to the housing to adjust the mirror reflective element relative to the mirror head.

7. The vehicular exterior rearview mirror assembly of claim 1, wherein the actuator comprises a first rocker arm and a second rocker arm, and wherein, when the actuator is electrically operated to adjust the rearward view for the driver of the vehicle, (i) the first rocker arm moves to adjust the mirror reflective element relative to the mirror head about a first pivot axis and (ii) the second rocker arm moves to adjust the mirror reflective element relative to the mirror head about a second pivot axis different from the first pivot axis.

8. The vehicular exterior rearview mirror assembly of claim 7, wherein the first rocker arm is coupled to the mirror reflective element via a first dampening mechanism, and wherein the second rocker arm is coupled to the mirror reflective element via a second dampening mechanism.

9. The vehicular exterior rearview mirror assembly of claim 1, wherein the mirror head is adjustable about the mounting structure, and wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide the rearward view to the driver of the vehicle and (ii) a folded position where the mirror head is folded inward from the extended position toward the side of the vehicle.

10. The vehicular exterior rearview mirror assembly of claim 9, wherein, with the vehicular exterior rearview mirror assembly mounted at the side of the vehicle, a powerfold actuator is electrically operable to move the mirror head relative to the mounting structure between the folded position and the extended position.

11. A vehicular exterior rearview mirror assembly, the vehicular exterior rearview mirror assembly comprising:
a mirror head disposed at a mounting structure, wherein the mounting structure is configured to mount the vehicular exterior rearview mirror assembly at a side of a vehicle;
wherein the mirror head accommodates a mirror reflective element attached at a mirror back plate;
wherein, with the vehicular exterior rearview mirror assembly mounted at the side of the vehicle, the mirror reflective element provides a rearward view at the side of the vehicle to a driver of the vehicle;
wherein the mirror head is adjustable about the mounting structure, and wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide the rearward view to the driver of the vehicle and (ii) a folded position where the mirror head is folded inward from the extended position toward the side of the vehicle;
an actuator accommodated within the mirror head, wherein, with the vehicular exterior rearview mirror assembly mounted at the side of the vehicle, the actuator is electrically operable to adjust the mirror reflective element relative to the mirror head to adjust the rearward view for the driver of the vehicle;
wherein the actuator comprises a rocker arm coupled to the mirror back plate, and wherein, when the actuator is electrically operated to adjust the rearward view for the driver of the vehicle, the rocker arm moves to adjust the mirror back plate and the mirror reflective element relative to the mirror head; and
wherein the rocker arm is coupled to the mirror back plate via a dampening mechanism, and wherein, with the vehicular exterior rearview mirror assembly mounted at the side of the vehicle, the dampening mechanism mitigates transfer of vibrations from the mounting structure and the actuator to the mirror back plate and the mirror reflective element.

12. The vehicular exterior rearview mirror assembly of claim 11, wherein the dampening mechanism comprises (i) a linkage disposed at an end portion of the rocker arm and (ii) a biasing element disposed between the linkage and the end portion of the rocker arm, and wherein the linkage is coupled to the mirror back plate, and wherein the biasing element imparts a biasing force between the linkage and the end portion of the rocker arm to urge the linkage in a direction away from the end portion of the rocker arm, and wherein the linkage moves relative to the end portion of the rocker arm to mitigate transfer of vibrations from the mounting structure and the actuator to the mirror back plate and the mirror reflective element.

13. The vehicular exterior rearview mirror assembly of claim 12, wherein the biasing element is disposed at least partially within a cavity of the linkage.

14. The vehicular exterior rearview mirror assembly of claim 13, wherein fluid is disposed within the cavity.

15. The vehicular exterior rearview mirror assembly of claim 11, wherein the actuator comprises a housing, and wherein the mirror back plate is adjustably attached to the housing of the actuator, and wherein, when the actuator is electrically operated to adjust the rearward view for the driver of the vehicle, the rocker arm moves relative to the housing to adjust the mirror back plate and the mirror reflective element relative to the mirror head.

16. The vehicular exterior rearview mirror assembly of claim 11, wherein the actuator comprises a first rocker arm and a second rocker arm, and wherein, when the actuator is electrically operated to adjust the rearward view for the driver of the vehicle, (i) the first rocker arm moves to adjust the mirror back plate and the mirror reflective element relative to the mirror head about a first pivot axis and (ii) the second rocker arm moves to adjust the mirror back plate and the mirror reflective element relative to the mirror head about a second pivot axis different from the first pivot axis.

17. The vehicular exterior rearview mirror assembly of claim 16, wherein the first rocker arm is coupled to the mirror back plate via a first dampening mechanism, and wherein the second rocker arm is coupled to the mirror back plate via a second dampening mechanism.

18. A vehicular exterior rearview mirror assembly, the vehicular exterior rearview mirror assembly comprising:
a mirror head disposed at a mounting structure, wherein the mounting structure is configured to mount the vehicular exterior rearview mirror assembly at a side of a vehicle;
wherein the mirror head accommodates a mirror reflective element attached at a mirror back plate;
wherein, with the vehicular exterior rearview mirror assembly mounted at the side of the vehicle, the mirror reflective element provides a rearward view at the side of the vehicle to a driver of the vehicle;
an actuator accommodated within the mirror head, wherein, with the vehicular exterior rearview mirror assembly mounted at the side of the vehicle, the actuator is electrically operable to adjust the mirror reflective element relative to the mirror head to adjust the rearward view for the driver of the vehicle;
wherein the actuator comprises a pivot element, and wherein the mirror back plate is adjustably attached to the pivot element of the actuator;
wherein the actuator comprises a first rocker arm coupled to the mirror back plate at a first location spaced from the pivot element and a second rocker arm coupled to the mirror back plate at a second location spaced from the pivot element and spaced from the first location, and wherein, when the actuator is electrically operated to adjust the rearward view for the driver of the vehicle, (i) the first rocker arm moves relative to the pivot element of the actuator to adjust the mirror back plate and the mirror reflective element relative to the pivot element and the mirror head about a first pivot axis and (ii) the second rocker arm moves relative to the pivot element of the actuator to adjust the mirror back plate and the mirror reflective element relative to the pivot element and the mirror head about a second pivot axis different from the first pivot axis; and
wherein the first rocker arm is coupled to the mirror back plate via a first dampening mechanism, and wherein the second rocker arm is coupled to the mirror back plate via a second dampening mechanism, and wherein, with the vehicular exterior rearview mirror assembly mounted at the side of the vehicle, the first dampening mechanism and the second dampening mechanism mitigate transfer of vibrations from the mounting structure and the actuator to the mirror back plate and the mirror reflective element.

19. The vehicular exterior rearview mirror assembly of claim 18, wherein the mirror head is adjustable about the mounting structure, and wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide the rearward view to the driver of the vehicle and (ii) a folded position where the mirror head is folded inward from the extended position toward the side of the vehicle.

20. The vehicular exterior rearview mirror assembly of claim 19, wherein, with the vehicular exterior rearview mirror assembly mounted at the side of the vehicle, a powerfold actuator is electrically operable to move the mirror head relative to the mounting structure between the folded position and the extended position.
